(19) United States
(12) Patent Application Publication
(10) Pub. No.: US 2026/0255362 A1
(43) Pub. Date: Aug. 27, 2026

(54) METHOD PERFORMED BY USER EQUIPMENT, METHOD PERFORMED BY BASE STATION AND DEVICES THEREOF

(71) Applicant: Samsung Electronics Co., Ltd., Suwon-si, Gyeonggi-do (KR)

(72) Inventors: Jingxing FU, Beijing (CN); Feifei SUN, Beijing (CN)

(21) Appl. No.: 18/879,070

(22) PCT Filed: Jun. 22, 2023
(86) PCT No.: PCT/KR2023/008671

§ 371 Date: Dec. 26, 2024

(30) Foreign Application Priority Data
Jun. 24, 2022 (CN) 202210730564.5

(51) Int. Cl. H04W 72/232; H04W 72/1263

(52) U.S. Cl. CPC H04W 72/232; H04W 72/1263

(57) ABSTRACT

The disclosure relates to a 5G or 6G communication system for supporting a higher data transmission rate. Embodiments herein provide method for managing multiple RRC connections support of MUSIM UE (100) in wireless network (1000) by MUSIM UE. The method includes detecting an event associated with a second SIM of a plurality of SIMs of the UE when a first SIM of the plurality of SIMs is in a connected state. Further, the method includes determining a MUSIM operation comprising a change in capability of a measurement gap and NCSG based on the event. Further, the method includes sending assistance information for the MUSIM operation using the first SIM to first network apparatus (200a). Further, the method includes receiving a request message with a gap configuration based on the change in capability of the measurement gap and the NCSG. Further, the method includes configuring the received gap configuration from the first network apparatus. Further, the method includes sending a response message to the first network apparatus.

### TECHNICAL FIELD

The present application relates to the field of communication technology and, specifically, to a method performed by an user equipment, a method performed by a base station, a user equipment, a base station and a computer readable storage medium in a communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

How to better improve the existing wireless communication methods and better meet the communication needs is a technical problem that technicians in this field have been working on.

### DISCLOSURE OF INVENTION

### Technical Problem

The purpose of the present application is to be able to solve at least one of the technical defects in the existing communication methods to better meet the communication needs. In order to achieve this purpose, the technical solutions proposed in the present application are as follows.

### Solution to Problem

According to a first aspect of the embodiments of the present disclosure, a method performed by a terminal in a communication system is proposed, the method may include: receiving, from a base station, first configuration information including information related to at least one cell scheduled by one downlink control information (DCI) format; determining a payload size of the one DCI format based on the information related to the at least one cell scheduled by the one DCI format, the payload size of the one DCI format being equal to a largest payload size associated with the at least one cell; and monitoring, based on the payload size of the one DCI format, a physical downlink control channel (PDCCH) for detecting the DCI format.

As an implementation, the method may further include: receiving, from the base station, second configuration information including information related to the number of cells scheduled by the one DCI format.

As an implementation, the information related to the number of cells scheduled by the one DCI format may include at least one of: the number of cells scheduled by the one DCI format; the maximum number of cells scheduled by the one DCI format; and a range of the number of cells scheduled by the one DCI format.

As an implementation, the information related to the at least one cell scheduled by the one DCI format may include at least one of: the number of cells scheduled by the one DCI format; an identifier of at least one cell scheduled by the one DCI format; an identifier of a cell group scheduled by the one DCI format and an identifier of at least one cell in the cell group; information of at least one bandwidth part (BWP) configured for each cell; and a physical downlink shared channel (PDSCH) and/or physical uplink shared channel (PUSCH) configuration for each cell.

As an implementation, the determining of the payload size of the one DCI format based on the information related to the at least one cell scheduled by the one DCI format may include: determining the payload size of the one DCI format based on at least one of: a PDSCH and/or PUSCH configuration of the at least one cell; a PDSCH and/or PUSCH configuration of an activated cell in the at least one cell; and a PDSCH and/or PUSCH configuration of a reference BWP of the at least one cell.

As an implementation, the reference BWP may include one of: an activated BWP of a cell; a BWP having a minimum index of a cell; a BWP having a maximum index of a cell; a BWP configured based on a high-level signaling of a cell; a BWP with a same subcarrier space configuration as an activated BWP of a scheduling cell; a BWP allowing multiple cells to be scheduled simultaneously by the one DCI format; and an activated BWP allowing multiple cells to be scheduled simultaneously by the one DCI format.

As an implementation, the first configuration information include a plurality of information related to at least one cell scheduled by one DCI format, wherein the determining of the payload size of the one DCI format may include: determining the number of bits of each DCI format; using a maximum value among the number of bits of each DCI format as the payload size of the one DCI format.

According to a second aspect of the embodiments of the present disclosure, a method performed by a base station in a communication system is provided, the method may include:

transmitting, to a terminal, first configuration information including information related to at least one cell scheduled by one downlink control information (DCI) format; determining a payload size of the one DCI format based on the information related to the at least one cell scheduled by the one DCI format, the payload size of the one DCI format being equal to a largest payload size associated with the at least one cell; generating, based on the payload size of the one DCI format, the DCI format; and transmitting the DCI format on a physical downlink control channel (PDCCH).

As an implementation, the method may further include: transmitting second configuration information including information related to the number of cells scheduled by the one DCI format.

As an implementation, the information related to the number of cells scheduled by the one DCI format may include at least one of: the number of cells scheduled by the one DCI format; the maximum number of cells scheduled by the one DCI format; and a range of the number of cells scheduled by the one DCI format.

As an implementation, the information related to the at least one cell scheduled by the one DCI format may include at least one of: the number of cells scheduled by the one DCI format; an identifier of at least one cell scheduled by the one DCI format; an identifier of a cell group scheduled by the one DCI format and an identifier of at least one cell in the cell group; information of at least one bandwidth part (BWP) configured for each cell; and a physical downlink shared channel (PDSCH) and/or physical uplink shared channel (PUSCH) configuration for each cell.

As an implementation, the determining of the payload size of the one DCI format based on the information related to the at least one cell scheduled by the one DCI format may include: determining the payload size of the one DCI format based on at least one of: a PDSCH and/or PUSCH configuration of the at least one cell; a PDSCH and/or PUSCH configuration of an activated cell in the at least one cell; and a PDSCH and/or PUSCH configuration of a reference BWP of the at least one cell.

As an implementation, the reference BWP may include one of: an activated BWP of a cell; a BWP having a minimum index of a cell; a BWP having a maximum index of a cell; a BWP configured based on a high-level signaling of a cell; a BWP with a same subcarrier space configuration as an activated BWP of a scheduling cell; a BWP allowing multiple cells to be scheduled simultaneously by the one DCI format; and an activated BWP allowing multiple cells to be scheduled simultaneously by the one DCI format.

As an implementation, the first configuration information may include a plurality of information related to at least one cell scheduled by one DCI format, wherein the determining of the payload size of the one DCI format may include: determining the number of bits of each DCI format; and using a maximum value among the number of bits of each DCI format as the payload size of the one DCI format.

According to a third aspect of the embodiments of the present disclosure, a user equipment is provided, including: a transceiver; and a processor coupled to the transceiver and configured to perform the above method performed by a user equipment.

According to a fourth aspect of the embodiments of the present disclosure, a base station is provided, including: a transceiver; and a processor, coupled to the transceiver and configured to perform the above method performed by a base station.

According to a fifth aspect of the embodiments of the present disclosure, an electronic device is provided, including: at least one processor; and at least one memory storing computer-executable instructions, wherein the computer-executable instructions, when run by the at least one processor, cause the at least one processor to perform any one of the methods as described above.

According to a sixth aspect of embodiments of the present disclosure, a computer-readable storage medium storing instructions is provided, the instructions, when run by at least one processor, cause the at least one processor to perform the methods as described above.

### Advantageous Effects of Invention

The technical solutions provided by the embodiments of the present disclosure brings at least the following beneficial effect: one DCI format is configured to be able to schedule PDSCHs and/or PUSCHs of multiple cells simultaneously, thereby saving resources occupied by PDCCHs scheduling PDSCHs/PUSCHs.

The beneficial effects brought by the technical solutions provided by the embodiments of the present application will be described later in connection with specific optional embodiments or may be known from the description of the embodiments, or may be learned from the implementation of the embodiments.

### BRIEF DESCRIPTION OF DRAWINGS

In order to more clearly and easily illustrate and understand the technical solutions in the embodiments of the present application, the following is a brief description of the accompanying drawings that need to be used in the description of the embodiments of the present application.

FIG. 1 illustrates an example wireless network according to various embodiments of the present application;

FIG. 2a illustrates an example wireless transmission path according to various embodiments of the present application;

FIG. 2b illustrates an example wireless reception path according to various embodiments of the present application;

FIG. 3a illustrates an example user equipment according to various embodiments of the present application;

FIG. 3b illustrates an example base station according to various embodiments of the present application;

FIG. 4 illustrates a flowchart of a method performed by a user equipment in a communication system provided by an embodiment of the present application;

FIG. 5 illustrates a flowchart of a communication method performed by a base station in a communication system provided by an embodiment of the present application;

FIG. 6 illustrates a block diagram of a user equipment in a communication system provided by an embodiment of the present application; and

FIG. 7 illustrates a block diagram of a base station in a communication system provided by an embodiment of the present application.

### MODE FOR THE INVENTION

Embodiments of the present application are described below in connection with accompanying drawings in the present application. It is to be understood that the embodiments set forth below in connection with the accompanying drawings are exemplary descriptions for explaining the technical solutions of the embodiments of the present application and do not constitute a limitation of the technical solutions of the embodiments of the present application.

It will be understood by those skilled in the art that, unless specifically stated, the singular forms “one”, “a”, “said” and “the” used herein may also include the plural form. It should be further understood that the terms “includes” and “comprises” as used in the embodiments of the present application mean that the corresponding features may be implemented as the features, information, data, steps, operations, elements and/ or components presented, but do not exclude the implementation of other features, information, data, steps, operations, elements, components and/or combinations thereof supported in the art. It should be understood that when we refer to an element being “connected” or “coupled” to another element, the component may be directly connected or coupled to the other element, or it may refer to the element and the other element being connected through an intermediate element. In addition, the “connect” or “couple” as used herein may include wireless connection or wireless coupling. The term “and/or” as used herein indicates at least one of the items defined by the term, for example, “A and/or B” may be implemented as “A”, or “B”, or “A and B”. When describing multiple (two or more) items, if the relationship between the multiple items is not explicitly defined, the multiple items may refer to one, more than one, or all of the multiple items, for example, the description “a parameter A includes A1, A2, A3” may be implemented that the parameter A includes A1 or A2 or A3, or that the parameter A includes at least two of the three parameters A1, A2, A3.

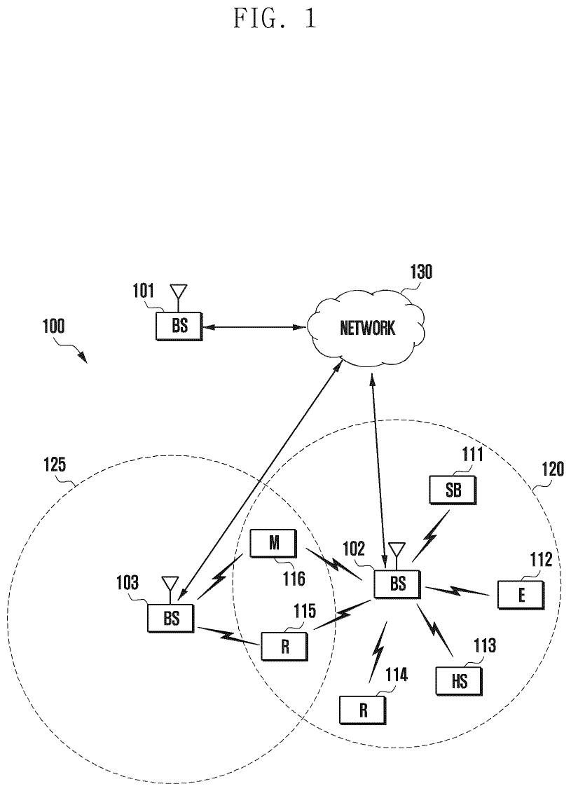

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

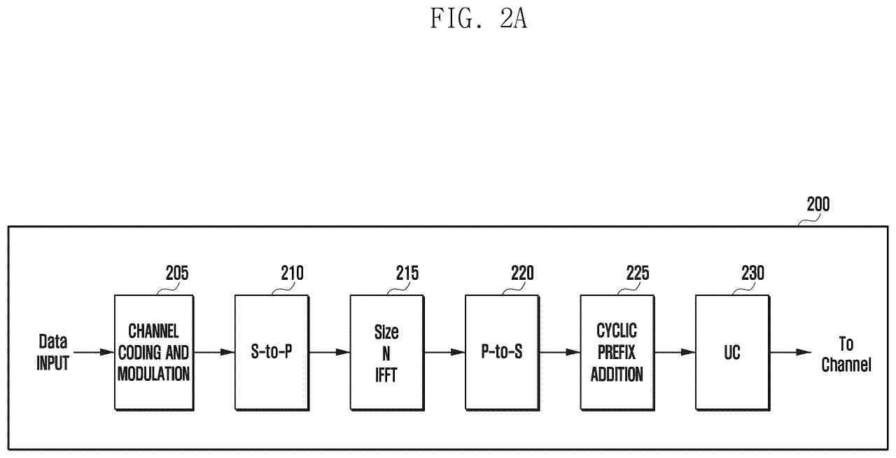

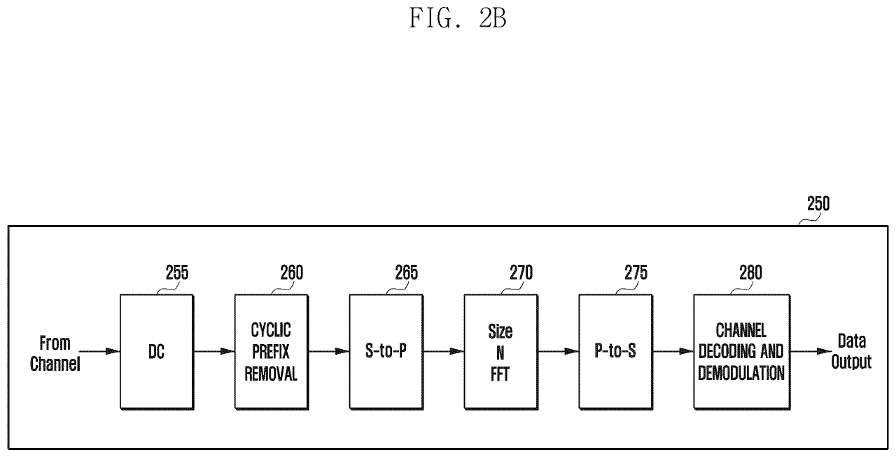

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

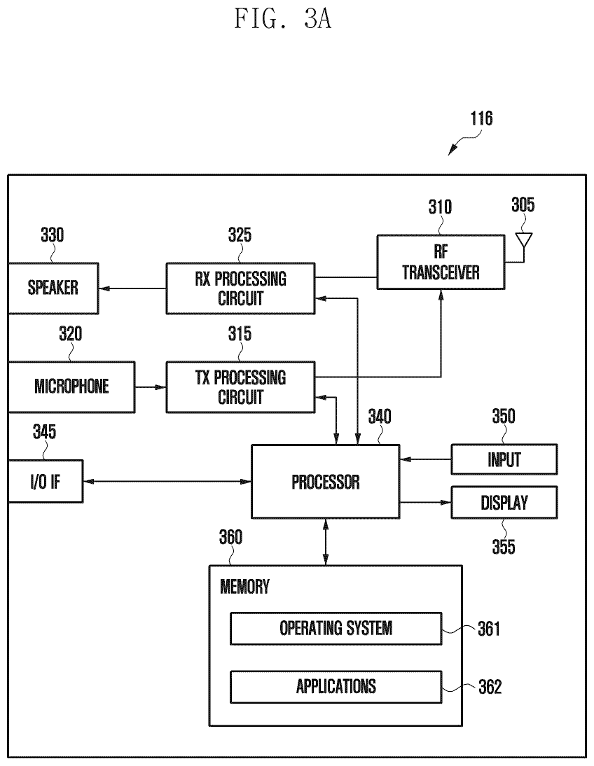

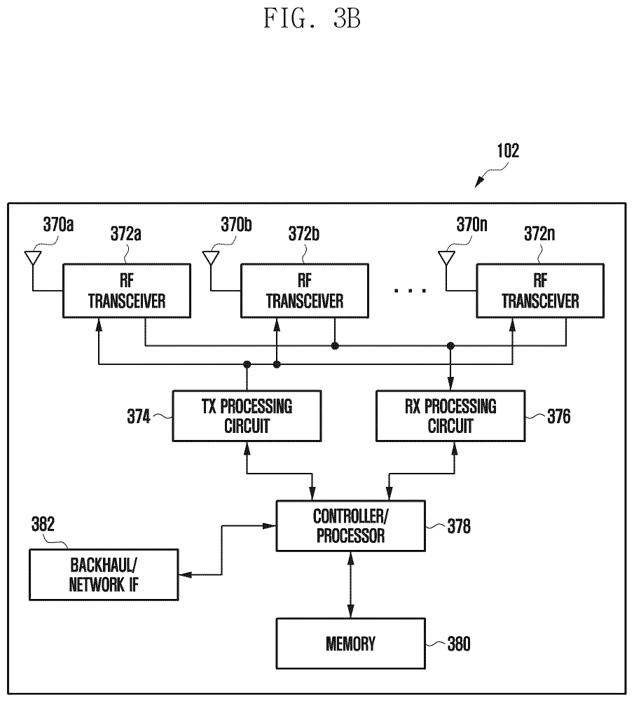

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/ controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/ controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/ controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370 a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

It is understood that the solutions provided by the embodiments of the present application may be applicable to, but not limited to, the wireless network described above.

In a communication system, a transmission from a base station to an user equipment (UE) is referred to as a downlink, and a transmission from an UE to a base station is referred to as an uplink. The downlink corresponds to a downlink transmission (which may also be called downlink sending or downlink emitting, etc.), and the downlink transmission includes at least one of transmissions of a downlink channel and a downlink signal, where the downlink channel includes a physical downlink shared channel (PDSCH), and a physical downlink control channel (PDCCH), and the downlink signal may include but is not limited to a downlink reference signal. Among them, the PDSCH is scheduled by downlink control information (DCI) in the PDCCH.

An uplink transmission includes at least one of transmissions of an uplink channel and an uplink signal, wherein the uplink channel includes a physical uplink shared channel (PUSCH), a physical uplink control channel (PUCCH), and a physical random access channel (PRACH), and the uplink signal may include but is not limited to an uplink reference signal. Among them, the PUSCH is scheduled by the downlink control information (DCI) in the PDCCH.

A PDSCH/PUSCH may be scheduled by a PDCCH of a same service cell as the PDSCH/PUSCH, called self-carrier-scheduling, or the PDSCH/PUSCH may be scheduled by a PDCCH of a different service cell from the PDSCH/PUSCH, called cross-carrier-scheduling. When an UE is configured with M (M is a positive integer) service cells, a PDSCH of one of the M service cells is self-carrier-scheduled by a PDCCH of that service cell, and PDSCHs of the remaining M−1 service cells are cross-carrier-scheduled by the PDCCH of the above service cell. For example, when the UE is configured with four service cells, i.e., service cell 1, service cell 2, service cell 3 and service cell 4, a PDSCH of the service cell 1 is self-carrier-scheduled by a PDCCH of service cell 1, and PDSCHs of service cell 2, service cell 3 and service cell 4 are cross-carrier-scheduled by the PDCCH of service cell 1.

Currently, one PDCCH may only schedule a PDSCH/PUSCH of one service cell, regardless of self-carrier-scheduling or cross-carrier-scheduling, for example, the UE is configured with two service cells, i.e., service cell 1 and service cell 2, and a PDCCH of service cell 1 schedules a PDSCH/PUSCH of service cell 1, which is called self-carrier-scheduling, and the PDCCH of service cell 1 schedules a PDSCH/PUSCH of service cell 2, which is called cross-carrier-scheduling. A payload size of a DCI format is determined according to a PDSCH/PUSCH configuration of an activated BWP of a scheduled service cell.

In order to reduce the resources occupied by the PDCCH scheduling the PDSCH/ PUSCH, the present disclosure proposes that a DCI format in one PDCCH simultaneously schedules a PDSCH/PUSCH of at least one service cell (such as two or more service cells), a method of determining the payload size of the DCI format is a problem to be studied.

The technical solutions of the present application and how the technical solutions of the present application solve the above technical problem are described in detail below in specific embodiments. The following specific embodiments may be combined with each other, and the same or similar concepts or processes may not be repeated in some embodiments. The exemplary embodiments of the present disclosure are described below in conjunction with the accompanying drawings. The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

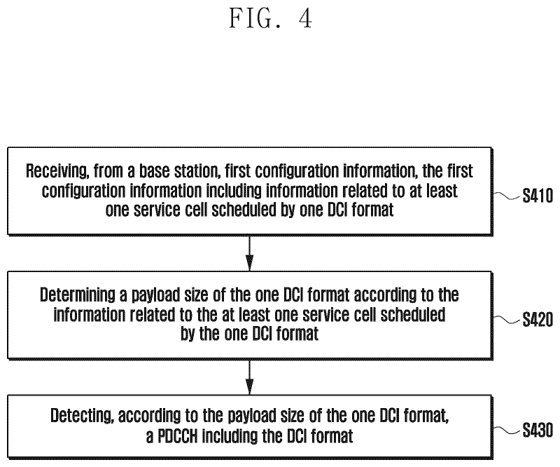

FIG. 4 illustrates a flowchart of a method performed by an user equipment in a communication system provided in an embodiment of the present application.

As illustrated in FIG. 4, at step S410, first configuration information is received from a base station. The first configuration information may include information related to at least one service cell scheduled by one DCI format. The base station may transmit the first configuration information to the UE via a signaling (e.g., a high-level signaling).

The first configuration information may be used to enable the user equipment to determine a DCI format for scheduling a physical downlink control channel (PDSCH) and/or a physical uplink control channel (PUSCH) of at least one service cell simultaneously. For example, the UE may determine a payload size or the number of bits of a DCI format based on the configuration information. The method illustrated in FIG. 4 may be used to determine a payload size of a DCI format for scheduling a PDSCH, may be used to determine a payload size of a DCI format for scheduling a PUSCH, or may be used to determine a payload size of a DCI format for scheduling both a PDSCH and a PUSCH. The following is an example of a method for determining a payload size of a DCI format for scheduling a PDSCH, which can also be used to determine a payload size of a DCI format for scheduling a PUSCH by replacing the PDSCH with the PUSCH in the following description.

In the present disclosure, several service cells scheduled simultaneously by one DCI format may be referred to as a simultaneous scheduling service cell group or a service cell group. The simultaneous scheduling service cell group may be configured by the base station. The base station may configure one or more simultaneous scheduling service cell groups for the UE. For example, the base station configures three simultaneous scheduling service cell groups for the UE, such as simultaneous scheduling service cell group 1, simultaneous scheduling service cell group 2 and simultaneous scheduling service cell group 3, and each simultaneous scheduling service cell group may include the same or different number of service cells, for example, the simultaneous scheduling service cell group 1 includes two service cells, the simultaneous scheduling service cell group 2 includes three service cells and the simultaneous scheduling service cell group 3 includes three service cells.

The information related to at least one service cell scheduled by one DCI format in the first configuration information may include at least one of: the number of service cells scheduled by one DCI format; an identifier of at least one service cell scheduled by one DCI format; an identifier of a service cell group scheduled by one DCI format and an identifier of at least one service cell in the service cell group; at least one BWP information configured for each service cell; a PDSCH and/or PUSCH configuration for each service cell.

For example, in a case where the UE is configured with multiple service cells, the first configuration information may include the number of service cells scheduled by one DCI format and an identifier of at least one service cell scheduled by one DCI format. The UE may determine which service cells will be scheduled simultaneously, based on the identifier of the service cell in the received first configuration information. In this case, the first configuration information may also include at least one BWP information configured for each service cell (e.g., the BWP information may be used to indicate which BWP in the service cell is referenced) and a PDSCH and/or PUSCH configuration for each service cell, for subsequent calculation of the number of information bits or the payload size of the DCI format. The above examples are only exemplary and the present disclosure is not limited thereto.

For example, in a case where the UE is configured with multiple simultaneous scheduling service cell groups, the first configuration information may include an identifier of a service cell group scheduled by one DCI format and an identifier of at least one service cell in that service cell group, and the identifier of the service cell group may be used to indicate the actually scheduled service cell group. The UE may determine which simultaneous scheduling service cell group will be scheduled based on the identifier of the service cell group in the received first configuration information. In this case, the first configuration information may also include at least one BWP information configured for each service cell and a PDSCH and/or PUSCH configuration for each service cell, for subsequent calculation of the number of information bits or the payload size of the DCI format. The above examples are only exemplary and the present disclosure is not limited thereto.

According to another embodiment of the present disclosure, the UE may receive second configuration information from the base station. The second configuration information may include information related to the number of service cells scheduled by one DCI format. The base station may transmit the second configuration information to the UE via a signaling (e.g., a high level signaling).

As an example, the information related to the number of service cells scheduled by one DCI format may include at least one of: the number of service cells scheduled by one DCI format; the maximum number of service cells scheduled by one DCI format; and a range of the number of service cells scheduled by one DCI format.

The information related to the number of service cells scheduled by one DCI format in the second configuration information may depend on the number of service cells configured for the UE. For example, the number of service cells whose PDSCHs are scheduled by the DCI format may be the configured fixed number of service cells, for example the configured number of service cells whose PDSCHs are scheduled by the DCI format is 4. For example, the number of service cells whose PDSCHs are scheduled by the DCI format may be the configured maximum number of service cells, for example, the DCI format may schedule 1, 2, 3, or 4 service cells if the configured maximum number of service cells whose PDSCHs are scheduled by the DCI format is 4. For example, the number of service cells whose PDSCHs are scheduled by the DCI format may be a configured range of the number of service cells, e.g., if the configured range of the number of service cells whose PDSCHs are scheduled by the DCI format is 3-4, the DCI format may schedule 3 or 4 service cells. The above examples are only exemplary, and the present disclosure is not limited thereto.

In the present disclosure, one DCI format corresponds to one DCI, thus the description “a PDSCH and/or PUSCH scheduled by a DCI format” may be understood as “a PDSCH and/or PUSCH scheduled by a DCI corresponding to a DCI format”.

The information related to the number of service cells scheduled by one DCI format in the second configuration information may be used to determine the number of service cells included in each simultaneous scheduling service cell group, or may be used to determine whether each simultaneous scheduling service cell group satisfies a quantity condition. For example, one or more simultaneous scheduling service cell groups may be configured for the UE based on the number of service cells whose PDSCHs and/or PUSCHs are simultaneously scheduled in the second configuration information, or one or more simultaneous scheduling service cell groups may be pre-configured by the base station for the UE, and then whether each pre-configured simultaneous scheduling service cell group satisfies the quantity condition is determined based on the number of service cells whose PDSCHs and/or PUSCHs are simultaneously scheduled in the second configuration information. For example, if the number of service cells included in the pre-configured simultaneous scheduling service cell group is less than or equal to the number of service cells whose PDSCHs and/or PUSCHs are simultaneously scheduled in the configuration information, it is determined that the quantity condition is satisfied.

The number of service cells scheduled by one DCI format in the first configuration information may represent the number of service cells actually scheduled. The number of service cells whole PDSCHs and/or PUSCHs are simultaneously scheduled included in the first configuration information may be the same as or different from the number of service cells whole PDSCHs and/or PUSCHs are simultaneously scheduled included in the second configuration information.

In a case where the UE is configured with one simultaneous scheduling service cell group, the configuration information received by the UE may include information related to at least one service cell scheduled by one DCI format in the first configuration information, and information related to the number of service cells scheduled by one DCI format in the second configuration information. Since the UE is configured with one simultaneous scheduling service cell group, the number of service cells whose PDSCHs and/or PUSCHs are simultaneously scheduled by one DCI format in the second configuration information may be equal to or greater than the number of service cells included in the simultaneous scheduling service cell group, and the information related to at least one service cell scheduled by one DCI format in the first configuration information may indicate which service cells the DCI format will schedule and/or formal information of the DCI format (such as a DCI format frame for filling the DCI format frame with subsequent calculated information bits to generate a corresponding DCI format).

In a case where the UE is configured with multiple simultaneous scheduling service cell groups, the number of service cells whose PDSCHs and/or PUSCHs are simultaneously scheduled (i.e. the information related to the number of service cells scheduled by one DCI format) in the second configuration information may include the number of service cells included in each of the one or more simultaneous scheduling service cell groups. For example, the base station configures three simultaneous scheduling service cell groups for the UE, such as simultaneous scheduling service cell group 1, simultaneous scheduling service cell group 2 and simultaneous scheduling service cell group 3, and each simultaneous scheduling service cell group may include the same or different number of service cells, for example the simultaneous scheduling service cell group 1 includes two service cells, the simultaneous scheduling service cell group 2 includes three service cells, and the simultaneous scheduling service cell group 3 includes three service cells. In this case, the number of service cells whose PDSCHs and/or PUSCHs are simultaneously scheduled in the second configuration information may include the number of service cells in the simultaneous scheduling service cell group 1 of 2, the number of service cells in the simultaneous scheduling service cell group 2 of 3, and the number of service cells in the simultaneous scheduling service cell group 3 of 3.

In this case, the number of service cells actually scheduled by one DCI format may be determined by the information related to at least one service cell scheduled by one DCI format in the first configuration information. For example, when a plurality of simultaneous scheduling service cell groups configured for the UE satisfy the number of service cells whose PDSCHs and/or PUSCHs are simultaneously scheduled in the second configuration information (e.g. the number of service cells in the simultaneous scheduling service cell group is less than or equal to the number of service cells whose PDSCHs and/or PUSCHs are simultaneously scheduled in the second configuration information), the information related to at least one service cell scheduled by one DCI format in the first configuration information may indicate how many service cells will actually be scheduled by the DCI format and which service cells will be scheduled (e.g. the service cells configured for the UE are indicated by cell identifiers, respectively, and the cell identifiers of the service cells to be scheduled may be included in the first configuration information to indicate which service cells will be scheduled). The number of service cells whose PDSCHs and/or PUSCHs are simultaneously scheduled in the second configuration information may be the configured fixed number of PDSCHs and/or PUSCHs scheduled by the DCI format, the configured maximum number of service cells whose PDSCHs and/or PUSCHs are scheduled by the DCI format, or a configured range of the number of service cells whose PDSCHs and/or PUSCHs are scheduled by the DCI format. A simultaneous scheduling service cell group in which the number of service cells is less than or equal to the number of service cells in the second configuration information may be used as a simultaneous scheduling service cell group that satisfies the condition.

For example, the UE is configured with six service cells, i.e., service cell 1, service cell 2, service cell 3, service cell 4, service cell 5 and service cell 6, where a PDSCH of service cell 1 is self-carrier-scheduled by a PDCCH of service cell 1, PDSCHs of the service cell 2, the service cell 3, the service cell 4, the service cell 5 and the service cell 6 are cross-carrier-scheduled by the PDCCH of service cell 1.The maximum number N of service cells whose PDSCHs are simultaneously scheduled by one DCI format, configured for the UE, is equal to 4, and the UE is configured with two simultaneous scheduling service cell groups, namely, simultaneous scheduling service cell group 1 and simultaneous scheduling service cell group 2, wherein the simultaneous scheduling service cell group 1 includes the service cell 1, the service cell 2, the service cell 3 and the service cell 4, and the simultaneous scheduling service cell group 2 includes the service cell 1, the service cell 5, and the service cell 6, and the number of service cells in each of the simultaneous scheduling service cell group 1 and the simultaneous scheduling service cell group 2 is less than or equal to the maximum number of service cells whose PDSCHs are simultaneously scheduled in the second configuration information, thus the simultaneous scheduling service cell group 1 and the simultaneous scheduling service cell group 2 may be used as service cell groups that satisfy the condition of the maximum number of service cells. The first configuration information may then be used to determine which simultaneous scheduling service cell group will actually be scheduled.

At step S420, a payload size of the one DCI format is determined based on the received information related to the at least one service cell scheduled by the one DCI format. The UE may determine the payload size of the DCI format based on the received configuration information. Here, the payload size may represent the size or the number of bits of the DCI format.

As an example, the information related to the at least one service cell scheduled by the one DCI format in the first configuration information may include at least one of the followings: the number of service cells scheduled by the one DCI format; an identifier of at least one service cell scheduled by the one DCI format; an identifier of a service cell group scheduled by the one DCI format and an identifier of at least one service cell in the service cell group; information of at least one BWP configured for each service cell; and a PDSCH and/or PUSCH configuration for each service cell. After the UE obtains the above information, the UE may obtain the number of service cells to be scheduled simultaneously by that DCI format and the identifiers of the service cells or the identifier of the service cell group to be scheduled, as well as the BWP information and the PDSCH and/or PUSCH configuration configured for each service cell. At this point, the UE may determine the payload size of the one DCI format based on at least one of the followings: PDSCH and/or PUSCH configurations of the simultaneously scheduled service cells; PDSCH and/or PUSCH configurations of activated service cells in the simultaneously scheduled service cells; and PDSCH and/or PUSCH configurations of reference BWPs of the simultaneously scheduled service cells. The reference BWP may be one of the followings: an activated BWP of a service cell; a BWP having a minimum index of a service cell; a BWP having a maximum index of a service cell; a BWP configured based on a high-level signaling of a service cell; a BWP with a same subcarrier space configuration as an activated BWP of a scheduled service cell; a BWP allowing multiple service cells to be scheduled simultaneously by the one DCI format; and an activated BWP allowing multiple service cells to be scheduled simultaneously by the one DCI format. The above examples are only exemplary and the present disclosure is not limited thereto.

For example, PDSCH and/or PUSCH configurations of the corresponding number of service cells may be determined according to the number of service cells whose PDSCHs and/or PUSCHs are simultaneously scheduled by one DCI format, and then the number of information bits of the DCI format may be determined based on the determined PDSCH and/or PUSCH configurations, and then the payload size of the DCI format may be determined based on the number of information bits.

Further, the UE may determine the payload size of the one DCI format based on the received first configuration information and second configuration information.

The number of service cells whose PDSCHs and/or PUSCHs are simultaneously scheduled by one DCI format in the second configuration information may be one of the followings: the configured fixed number of service cells, the configured maximum number of service cells, a configured range of the number of service cells. For example, the configured number of service cells whose PDSCHs are scheduled by a DCI format is 4. For another example, the configured maximum number of service cells whose PDSCHs are scheduled by a DCI format is 4, and in this case, the DCI format may schedule 1, 2, 3, or 4 service cells, i.e., the DCI format may schedule PDSCHs of the number of service cells that does not exceed the maximum number of service cells. For yet another example, when the configured range of the number of service cells whose PDSCHs are scheduled by a DCI format is 3 to 4, the DCI format may schedule 3 or 4 service cells, i.e., the DCI format may schedule PDSCHs of the number of service cells that does not exceed the range. The number of information bits of the DCI format may be determined based on the PDSCH and/or PUSCH configurations of the corresponding number of service cells, and the cell information (such as cell identifier or cell group identifier, BWP information, etc.) indicating the service cells to be scheduled in the second configuration information as described above, and then the payload size of the DCI format may be determined based on the number of information bits.

In a case where the UE is configured with one simultaneous scheduling service cell group, the number of service cells whose PDSCHs and/or PUSCHs simultaneously scheduled by one DCI format in the second configuration information may be equal to or greater than the number of service cells included in the simultaneous scheduling service cell group since the UE is configured with one simultaneous scheduling service cell group, and the second configuration information may indicate which service cells the DCI format will schedule and/or formal information of the DCI format (such as a DCI format frame, wherein the DCI format frame is filled with subsequently calculated information bits to generate a corresponding DCI format). In this case, the number of service cells whose PDSCHs and/or PUSCHs are simultaneously scheduled in the second configuration information may be the same as the number of service cells actually scheduled as indicated in the first configuration information.

It is assumed that the UE is configured with four service cells, i.e., service cell 1, service cell 2, service cell 3 and service cell 4, the maximum number N of service cells whose PDSCHs simultaneous scheduled by one DCI format configured for the UE is equal to 4, and the UE is configured with one simultaneous scheduling service cell group which may include the service cell 1, the service cell 2, the service cell 3 and the service cell 4, and the payload size of the DCI format is determined based on the PDSCH configurations of the service cell 1, the service cell 2, the service cell 3 and the service cell 4 included in the simultaneous scheduling service cell group. In this case, it is possible to first determine which service cells will be scheduled, based on the first configuration information, and then determine the payload size of the DCI format for scheduling these service cells, based on the PDSCH configurations of these indicated service cells.

In addition, when determining the payload size of the DCI format, it may be determined whether the service cell to be scheduled is an activated service cell, and then the payload size of the DCI format may be determined based on the PDSCH configuration of the activated service cell.

For example, the UE is configured with four service cells, i.e., service cell 1, service cell 2, service cell 3 and service cell 4, the maximum number N of service cells whose PDSCHs are simultaneously scheduled by one DCI format configured for the UE is equal to four, and the UE is configured with one simultaneous scheduling service cell group that includes the service cell 1, the service cell 2, the service cell 3 and the service cell 4, where the service cell 1, the service cell 2 and the service cell 3 are activated service cells and the service cell 4 is an inactivated service cell, and in this case, the payload size of the DCI format may be determined based on the PDSCH configurations of the activated service cells (i.e. the service cell 1, the service cell 2 and the service cell 3) in this simultaneous scheduling service cell group.

In a case where the UE is configured with multiple simultaneous scheduling service cell groups, it is assumed that the base station configures three simultaneous scheduling service cell groups for the UE, and each simultaneous scheduling service cell group may include the same or different number of service cells, for example simultaneous scheduling service cell group 1 includes two service cells, simultaneous scheduling service cell group 2 includes three service cells and simultaneous scheduling service cell group 3 includes three service groups. For each simultaneous scheduling service cell group, the PDSCH and/or PUSCH configurations of the service cells within the corresponding simultaneous scheduling service cell group may be determined, and the payload size of the DCI format for scheduling the simultaneous scheduling service cell group may be determined based on the PDSCH and/or PUSCH configurations of the simultaneous scheduling service cell group. After determining the payload size of the DCI format for scheduling the corresponding simultaneous scheduling service cell group, the identifier of the service cell group in the first configuration information may be used to determine the simultaneous scheduling service cell group to be actually scheduled.

If the base station has pre-configured multiple simultaneous scheduling service cell groups for the UE, the UE may determine PDSCH and/or PUSCH configurations for each simultaneous scheduling service cell group respectively and then determine PDSCH and/or PUSCH configurations to be used based on the first configuration information.

According to another example, the UE, after receiving the second configuration information, may perform any combination of the service cells configured for the UE to form a plurality of simultaneous scheduling service cell groups based on the number of service cells whose PDSCHs and/or PUSCHs are simultaneously scheduled in the second configuration information, and then determine PDSCH and/or PUSCH configurations of each simultaneous scheduling service cell group. The PDSCH and/or PUSCH configurations of the simultaneous scheduling service cell group corresponding to the first configuration information is selected to determine the payload size of the DCI format for scheduling the simultaneous scheduling service cell group.

According to another embodiment of the present disclosure, in a case where the first configuration information includes a plurality of information related to at least one service cell scheduled by one DCI format, in order to reduce the number of different DCI format sizes for blind detection by the UE, the UE may determine the number of bits of each DCI format and then use the maximum value among the number of bits of each DCI format as the payload size of that one DCI format.

After determining the PDSCH and/or PUSCH configurations of the service cells within each service cell group, the number of information bits of each service cell group may be determined based on the PDSCH and/or PUSCH configurations of each service cell group, and then the number of information bits of each service cell group may be aligned.

According to the embodiments of the present disclosure, if the UE is configured with more than one simultaneous scheduling service cell group and the number of service cells within each simultaneous scheduling service cell group i is Mi, the number of information bits of a DCI format for scheduling a simultaneous scheduling service cell group is determined based on the PDSCH configurations of all configured service cells within that simultaneous scheduling service cell group. In order not to increase the number of different DCI sizes that need to be blindly detected by the UE too much, it is necessary to align the payload sizes of the DCI formats for scheduling multiple simultaneous scheduling service cell groups. A possible method is to identify a simultaneous scheduling service cell group with the largest number of information bits of a DCI format among multiple simultaneous scheduling service cell groups, use the number of information bits of the DCI format of this simultaneous scheduling service cell group as the payload size of the DCI format, and then the number of information bits of the DCI formats of the remaining simultaneous scheduling service cell groups are appended with zeros, so that the payload sizes of the DCI formats appended with zeros are the same as the above DCI format with the largest number of information bits, so that each simultaneous scheduling service cell group has the same number of information bits of the DCI format.

For example, the UE is configured with six service cells, namely service cell 1, service cell 2, service cell 3, service cell 4, service cell 5 and service cell 6, where the PDSCH of the service cell 1 is self-carrier-scheduled by the PDCCH of the service cell 1, the PDSCHs of the service cell 2, the service cell 3, the service cell 4, the service cell 5 and the service cell 6 are cross-carrier-scheduled by the PDCCH of the service cell 1, and the maximum number N of service cells whose PDSCHs are simultaneously scheduled by one DCI format configured for the UE is equal to 4, and the UE is configured with two simultaneous scheduling service cell groups, namely simultaneous scheduling service cell group 1 and simultaneous scheduling service cell group 2,where the simultaneous scheduling service cell group 1 includes the service cell 1, the service cell 2, the service cell 3 and the service cell 4, and the simultaneous scheduling service cell group 2 includes the service cell 1, the service cell 5 and the service cell 6, and the number of information bits of a DCI format is determined as L1 according to the PDSCH configurations of the service cell 1, the service cell 2, the service cell 3 and the service cell 4 included in the simultaneous scheduling service cell group 1, and the number of information bits of a DCI format is determined as L2 according to the PDSCH configurations of the service cell 1, the service cell 5 and the service cell 6 included in the simultaneous scheduling service cell group 2. It is assumed that L1 is greater than L2, the DCI format of the simultaneous scheduling service cell group 2 is appended with (L1-L2) zeros, so that the payload size of the DCI format of the simultaneous scheduling service cell group 2 is the same as the payload size of the DCI format of the simultaneous scheduling service cell group 1. The advantage of using this method is that it may reduce the number of different DCI format sizes for blind detection by the UE as much as possible while ensuring the PDSCH scheduling requirement.

According to another embodiment of the present disclosure, if the UE is configured with more than one simultaneous scheduling service cell group, and the number of service cells within each simultaneous scheduling service cell group i is Mi, the number of information bits of each DCI format for scheduling each simultaneous scheduling service cell group is determined according to PDSCH configurations of activated service cells in all configured service cells within the simultaneous scheduling service cell group (or non-dormancy service cells in the activated service cells, the non-dormancy service cell means that the activated BWP of the service cell is not a dormancy BWP), and then, in order not to increase the number of different DCI sizes that need to be blindly detected by the UE too much, it is necessary to align the payload sizes of the DCI formats for scheduling multiple simultaneous scheduling service cell groups. A possible method is to identify a simultaneous scheduling service cell group with the largest number of information bits of a DCI format among multiple simultaneous scheduling service cell groups, use the number of information bits of the DCI format of this simultaneous scheduling service cell group as the payload size of the DCI format for reference, and then the number of information bits of the DCI formats of the remaining simultaneous scheduling service cell groups are appended with zeros, so that the payload sizes of the DCI formats appended with zeros are equal to the largest number of information bits of the above DCI format.

For example, the UE is configured with six service cells, namely service cell 1, service cell 2, service cell 3, service cell 4, service cell 5 and service cell 6, where the PDSCH of the service cell 1 is self-carrier-scheduled by the PDCCH of the service cell 1, the PDSCHs of the service cell 2, the service cell 3, the service cell 4, the service cell 5 and the service cell 6 are cross-carrier-scheduled by the PDCCH of the service cell 1, and the maximum number N of service cells whose PDSCHs are simultaneously scheduled by one DCI format configured for the UE is equal to 4, and the UE is configured with two simultaneous scheduling service cell groups, namely simultaneous scheduling service cell group 1 and simultaneous scheduling service cell group 2, where the simultaneous scheduling service cell group 1 includes the service cell 1, the service cell 2, the service cell 3 and the service cell 4, and the simultaneous scheduling service cell group 2 includes the service cell 1, the service cell 5 and the service cell 6, and the number of information bits of a DCI format is determined as L1 according to PDSCH configurations of activated service cells (for example, the service cell 1, the service cell 2, the service cell 3, and the service cell 4 are activated service cell) in the service cell 1, the service cell 2, the service cell 3 and the service cell 4 included in the simultaneous scheduling service cell group 1, and the number of information bits of a DCI format is determined as L2 according to PDSCH configurations of activated service cells (for example, the service cell 1 and the service cell 6 are activated service cell) in the service cell 1, the service cell 5 and the service cell 6 included in the simultaneous scheduling service cell group 2 (the service cell 5 included in the simultaneous scheduling service cell group 2 is an inactivated service cell). It is assumed that L1 is greater than L2, the number of information bits of the DCI format for scheduling of the simultaneous scheduling service cell group 2 is appended with (L1-L2) zeros, so that the payload size of the DCI format for scheduling simultaneous scheduling service cell group 2 is the same as the payload size of the DCI format for scheduling the simultaneous scheduling service cell group 1. The advantage of using this method is that it may reduce the number of different DCI format sizes for blind detection by the UE as much as possible while ensuring the PDSCH scheduling requirement.

After the alignment operation, the simultaneous scheduling service cell group to be used may be found based on the first configuration information.

In a case where a service cell is configured with one bandwidth part (BWP), PDSCH and/or PUSCH configuration of the service cell may be determined directly from PDSCH and/or PUSCH configuration of the BWP in the service cell in the manner described above.

In a case where a service cell is configured with more than one BWP, a reference BWP of the service cell may first be determined and PDSCH and/or PUSCH configuration of the reference BWP of the service cell may be used as PDSCH and/or PUSCH configuration of that service cell. For example, one of the following items may be used as the reference BWP: an activated BWP in a service cell; a BWP having a minimum index in a service cell; a BWP having a maximum index in a service cell; a BWP configured based on a high-level signaling in a service cell; a BWP with a same subcarrier space configuration as an activated BWP in a scheduling service cell; a BWP allowing PDSCHs of multiple service cells to be scheduled simultaneously by the one DCI format; and an activated BWP allowing PDSCHs of multiple service cells to be scheduled simultaneously by the one DCI format. For example, the reference BWP of the service cell may be determined based on BWP information in the first configuration information.

For example, the reference BWP in the service cell may be a BWP configured by a high-level signaling.

Alternatively, the reference BWP in the service cell may be a BWP having a maximum index in a service cell.

Alternatively, the reference BWP in the service cell may be a BWP having a maximum index in a service cell.

Alternatively, the reference BWP in the service cell may be a BWP in a service cell with a same subcarrier space configuration as an activated BWP in a scheduling service cell. For example, service cell 1 is a scheduling cell and service cell 2 is a scheduled cell. When one DCI format in the service cell 1 simultaneously schedules PDSCHs of the service cell 1 and the service cell 2, a subcarrier space configuration (μ) of an active BWP of the service cell 1 is equal to 0, the service cell 2 is configured with 2 downlink BWPs, namely BWP-1 and BWP-2, and a subcarrier space configuration (μ) of BWP-1 is equal to 0 and a subcarrier space configuration (μ) of BWP-2 is equal to 1. At this time, BWP-1 of the service cell 2 is the reference BWP.

Alternatively, the reference BWP in the service cell may be a downlink BWP in the service cell by which one DCI format may schedule PDSCHs of multiple service cells. For example, service cell 1 is a scheduling cell and service cell 2 is a scheduled cell, and when one DCI format in the service cell 1 simultaneously schedules PDSCHs of the service cell 1 and the service cell 2, the service cell 2 is configured with two downlink BWPs, namely BWP-1 and BWP-2 respectively, where the PDSCH in BWP-1 may only be scheduled by one DCI format for only scheduling one PDSCH and cannot be scheduled by one DCI format for simultaneously scheduling the PDSCH of the service cell 1 and the PDSCH of the service cell 2, and the PDSCH in BWP-2 may be scheduled by one DCI format for simultaneously scheduling the PDSCH of the service cell 1 and the PDSCH of the service cell 2, at this time, BWP-2 of the serving cell 2 is the reference BWP.

According to another embodiment of the present disclosure, in a case where there is an activated BWP in a service cell, the activated BWP in the service cell may be used as a reference BWP of the service cell, and in a case where there is no activated BWP in a service cell, one of the following BWPs in the service cell may be used as a reference BWP of the service cell: a BWP with a minimum index, a BWP with a maximum index, a BWP configured based on a high level signaling, a BWP with a same subcarrier space configuration as an activated BWP in a scheduling service cell, and a BWP allowing PDSCHs of multiple service cells to be scheduled simultaneously by a DCI format.

For example, a PDSCH configuration of an activated BWP in a service cell is used as a PDSCH configuration of the service cell. If there is no activated BWP in the service cell, the PDSCH configuration of the reference BWP in the service cell may be used as the PDSCH configuration of the service cell. The reference BWP in the service cell may be a BWP configured by a high level signaling, or a BWP with the smallest index in the service cell, or the BWP with the largest index in the service cell.

As another example, when there is no activated BWP in a service cell, or when an activated BWP is a dormancy BWP, the service cell may be removed when calculating a payload size of a DCI format, i.e., a PDSCH and/or PUSCH configuration of the service cell is not considered.

As yet another example, in a case where a service cell does not have a reference BWP of the above type, the service cell may be removed when calculating a payload size of a DCI format, i.e. a PDSCH and/or PUSCH configuration of the service cell is not considered.

According to the embodiments of the present disclosure, the first configuration information may include cell identifiers of service cells that are scheduled at the same time. In this way, the UE may separately determine a PDSCH and/or PUSCH configuration of each of configured service cells, and then determine service cells to be scheduled based on the first configuration information, determine the payload size of the DCI format by using the PDSCH and/or PUSCH configuration of the service cells to be scheduled.

The above examples are only exemplary and the present disclosure is not limited thereto.

According to the embodiments of the present disclosure, in determining the payload size of the DCI format, whether the service cell is an active service cell and/or a BWP of the service cell, etc. may be considered. The payload size of the DCI format may be determined based on different considerations.

In step S430, a physical downlink control channel (PDCCH) including the DCI format is detected according to the payload size of the one DCI format. The UE may determine the payload size of the DCI format based on the determined number of bits of the DCI format, and detect the DCI format corresponding to the determined payload size in the PDCCH. The UE may obtain data in the scheduled PUSCH and/or the PDSCH according to the detected DCI format. In the present disclosure, detecting a DCI format may be understood as finding DCI corresponding to the payload size of the DCI format.

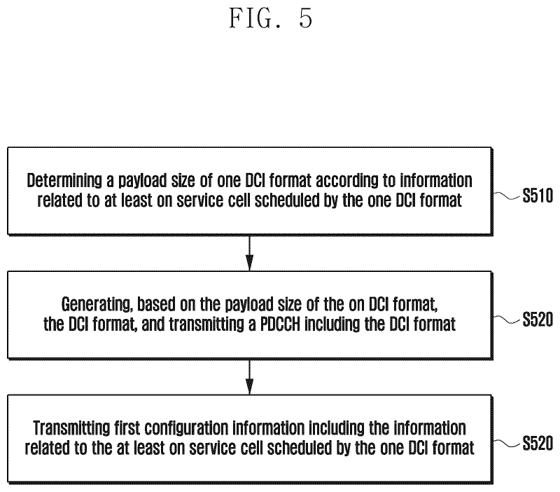

FIG. 5 illustrates a flowchart of a communication method performed by a base station in a communication system provided by an embodiment of the present application. The method illustrated in FIG. 5 may be used by the base station to determine a payload size of a DCI format for scheduling a PDSCH, or may be used to determine a payload size of a DCI format for scheduling a PUSCH, or may be used to determine a payload size of a DCI format for scheduling both the PDSCH and the PUSCH.

With reference to FIG. 5, in step S510, a payload size of one downlink control information (DCI) format is determined according to information related to at least one service cell scheduled by the one DCI format. Here, the payload size may mean a size or the number of bits of one DCI format.

The payload size of the DCI format is generated according to first configuration information. For example, the first configuration information may be the first configuration information as described in FIG. 4. The information related to at least one service cell scheduled by one DCI format in the first configuration information may include at least one of: the number of service cells scheduled by one DCI format; an identifier of at least one service cell scheduled by one DCI format; an identifier of a service cell group scheduled by one DCI format and an identifier of at least one service cell in the service cell group; at least one BWP information configured for each service cell; a PDSCH and/or PUSCH configuration for each service cell.

After obtaining the above information, the base station may obtain the number of service cells to be scheduled simultaneously by one DCI format and identifiers of the service cells or an identifier of a service cell group to be scheduled, as well as BWP information and a PDSCH and/or PUSCH configuration configured for each service cell. At this point, the base station may determine the payload size of the one DCI format based on at least one of the followings: PDSCH and/or PUSCH configurations of simultaneously scheduled service cells; PDSCH and/or PUSCH configurations of activated service cells in the simultaneously scheduled service cells; and PDSCH and/ or PUSCH configurations of reference BWPs of the simultaneously scheduled service cells. The payload size of this DCI format is then determined based on the PDSCH and/or PUSCH configurations.

In addition, the payload size of the DCI format may be generated based on the first configuration information and second configuration information. The second configuration information may include information related to the number of service cells scheduled by the one DCI format. The information related to the number of service cells scheduled by the one DCI format may include at least one of the number of service cells scheduled by the one DCI format; the maximum number of service cells scheduled by the one DCI format; and a range of the number of service cells scheduled by the one DCI format.

For example, the base station may determine PDSCH and/or PUSCH configurations of the corresponding number of service cells based on the number of service cells whose PDSCHs and/or PUSCHs are simultaneously scheduled by one DCI format in the second configuration information, and then determine a payload size of the corresponding DCI format based on the second configuration information. For example, the payload size of the corresponding DCI format is determined based on the corresponding number of PDSCH and/or PUSCH configurations and identifiers of service cells to be scheduled as indicated in the first configuration information.

The number of service cells whose PDSCHs and/or PUSCHs simultaneously scheduled by one DCI format in the second configuration information may be one of the configured fixed number of service cells, the configured maximum number of service cells, a configured range of the number of service cells. For example, the configured number of service cells whose PDSCHs are scheduled by the DCI format is 4. For example, the configured number of service cells whose PDSCHs are scheduled by the DCI format may be the configured maximum number of service cells, for example, in a case where the configured maximum number of service cells whose PDSCHs are scheduled by the DCI format is 4, the DCI format may schedule 1, 2, 3, or 4 service cells. For example, the configured range of the number of service cells whose PDSCHs are scheduled by the DCI format is 3 to 4, the DCI format may schedule 3 or 4 service cells. The above examples are exemplary only and the present disclosure is not limited thereto.

The number of service cells whose PDSCHs and/or PUSCHs are simultaneously scheduled in the second configuration information may be used to determine the number of service cells included in each simultaneous scheduling service cell group, or may be used to determine whether each simultaneous scheduling service cell group satisfies a quantity condition. For example, one or more simultaneous scheduling service cell groups may be configured for the UE based on the number of service cells whose PDSCHs and/or PUSCHs are simultaneously scheduled in the second configuration information, or one or more simultaneous scheduling service cell groups may be pre-configured by the base station for the UE and then whether each pre-configured simultaneous scheduling service cell group satisfies the quantity condition is determined based on the number of service cells whose PDSCHs and/or PUSCHs are simultaneously scheduled in the second configuration information. For example, if the number of service cells included in the pre-configured simultaneous scheduling service cell group is less than or equal to the number of service cells whose PDSCHs and/or PUSCHs are simultaneously scheduled in the configuration information, it is determined that the quantity condition is satisfied.

The number of service cells whose PDSCHs and/or PUSCHs are simultaneously scheduled in the second configuration information may be the same as or different from the number of service cells indicated in the first configuration information.

It is assumed that the UE is configured with four service cells, i.e., service cell 1, service cell 2, service cell 3 and service cell 4, the maximum number N of service cells whose PDSCHs are simultaneous scheduled by one DCI format configured for the UE is equal to 4, and the UE is configured with one simultaneous scheduling service cell group which may include the service cell 1, the service cell 2, the service cell 3 and the service cell 4, and the payload size of the DCI format is determined based on the PDSCH configurations of the service cell 1, the service cell 2, the service cell 3 and the service cell 4 included in the simultaneous scheduling service cell group.

According to another example, the base station may determine whether each of service cells is an activated service cell, and use a PDSCH and/or PUSCH configuration of the activated service cell as a PDSCH and/or PUSCH configuration of the service cell.

For example, the UE is configured with four service cells, service cell 1, service cell 2, service cell 3 and service cell 4, the maximum number N of service cells whose PDSCHs are simultaneously scheduled by one DCI format configured for the UE is equal to four, and the UE is configured with one simultaneous scheduling service cell group that includes the service cell 1, the service cell 2, the service cell 3 and the service cell 4, where the service cell 1, the service cell 2 and the service cell 3 are activated service cells and the service cell 4 is an inactivated service cell, in this case, the payload size of the DCI format may be determined based on the PDSCH configurations of the activated service cells (i.e. the service cell 1, the service cell 2 and the service cell 3) in this simultaneous scheduling service cell group.

It is assumed that the base station configures three simultaneous scheduling service cell groups for one UE, and each simultaneous scheduling service cell group may include the same or different number of service cells, for example simultaneous scheduling service cell group 1 includes two service cells, simultaneous scheduling service cell group 2 includes three service cells and simultaneous scheduling service cell group 3 includes three service groups. For each simultaneous scheduling service cell group, the PDSCH and/or PUSCH configurations of the corresponding simultaneous scheduling service cell group to be scheduled may be determined, and the payload size of the DCI format for scheduling the simultaneous scheduling service cell group may be determined based on the PDSCH and/or PUSCH configurations of the simultaneous scheduling service cell group. Then, according to the first configuration information, the simultaneous scheduling service cell group to be actually scheduled is determined. That is, when the UE is pre-configured with multiple simultaneous scheduling service cell groups, the PDSCH and/or PUSCH configurations of each simultaneous scheduling service cell group may be determined, the number of information bits of the DCI format for scheduling the corresponding simultaneous scheduling service cell group may be determined based on the PDSCH and/or PUSCH configurations of each simultaneous scheduling service cell group, and the payload size of the corresponding DCI format is then determined based on the number of information bits of the corresponding DCI format. After determining the payload size of the DCI format, the information related to at least one service cell scheduled by one DCI format in the first configuration information may be used to determine which simultaneous scheduling service cell group is to be scheduled.

If the base station has pre-configured multiple simultaneous scheduling service cell groups for the UE, the base station may determine PDSCH and/or PUSCH configurations for each simultaneous scheduling service cell group respectively and then determine PDSCH and/or PUSCH configurations to be used based on the first configuration information.

As another example, the base station may perform any combination of the service cells configured for the UE to form a plurality of simultaneous scheduling service cell groups based on the number of service cells whose PDSCHs and/or PUSCHs are simultaneously scheduled in the second configuration information, and then determine PDSCH and/or PUSCH configurations of each simultaneous scheduling service cell group. The PDSCH and/or PUSCH configurations of the simultaneous scheduling service cell group corresponding to the first configuration information is selected to determine the payload size of the DCI format for scheduling the simultaneous scheduling service cell group.

In a case where the first configuration information includes a plurality of information related to at least one service cell by scheduled one DCI format, in order to reduce the number of different DCI format sizes for blind detection by the UE, the base station may determine the number of bits of each DCI format and then use the maximum value among the number of bits of each DCI format as the payload size of that one DCI format.

As an example, after determining the PDSCH and/or PUSCH configurations of the service cells within each service cell group, the number of information bits of each service cell group may be determined based on the PDSCH and/or PUSCH configurations of each service cell group, and then the number of information bits of each service cell group may be aligned. For example, in a case where the UE is configured with at least one service cell group, each service cell group including at least one service cell scheduled simultaneously, the base station may determine the PDSCH and/ or PUSCH configurations of service cells within each service cell group, determine the number of information bits of each service cell group based on the PDSCH and/or PUSCH configurations of each service cell group, then align the number of information bits of each service cell group, and determine the payload size of the DCI format based on the aligned number of information bits and the first configuration information.

As an example, if the UE is configured with more than one simultaneous scheduling service cell group and the number of service cells within each simultaneous scheduling service cell group i is Mi, the number of information bits of a DCI format for scheduling a simultaneous scheduling service cell group is determined based on the PDSCH configurations of all configured service cells within that simultaneous scheduling service cell group. In order not to increase the number of different DCI sizes that need to be blindly detected by the UE too much, it is necessary to align the payload sizes of the DCI formats for scheduling multiple simultaneous scheduling service cell groups. A possible method is to identify a simultaneous scheduling service cell group with the largest number of information bits of a DCI format among multiple simultaneous scheduling service cell groups, use the number of information bits of the DCI format of this simultaneous scheduling service cell group as the payload size of the DCI format, and then the number of information bits of the DCI formats of the remaining simultaneous scheduling service cell groups are appended with zeros, the payload sizes of the DCI formats appended with zeros have the number of information bits which is same as the largest number of information bits of the above DCI format, so that each simultaneous scheduling service cell group has the same number of information bits of the DCI format.

For example, the UE is configured with six service cells, namely service cell 1, service cell 2, service cell 3, service cell 4, service cell 5 and service cell 6, where the PDSCH of the service cell 1 is self-carrier-scheduled by the PDCCH of the service cell 1, the PDSCHs of the service cell 2, the service cell 3, the service cell 4, the service cell 5 and the service cell 6 are cross-carrier-scheduled by the PDCCH of the service cell 1, and the maximum number N of service cells whose PDSCHs are simultaneously scheduled by one DCI format configured for the UE is equal to 4, and the UE is configured with two simultaneous scheduling service cell groups, namely simultaneous scheduling service cell group 1 and simultaneous scheduling service cell group 2,where the simultaneous scheduling service cell group 1 includes the service cell 1, the service cell 2, the service cell 3 and the service cell 4, and the simultaneous scheduling service cell group 2 includes the service cell 1, the service cell 5 and the service cell 6, and the number of information bits of a DCI format is determined as L1 according to the PDSCH configurations of the service cell 1, the service cell 2, the service cell 3 and the service cell 4 included in the simultaneous scheduling service cell group 1, and the number of information bits of a DCI format is determined as L2 according to the PDSCH configurations of the service cell 1, the service cell 5 and the service cell 6 included in the simultaneous scheduling service cell group 2. It is assumed that L1 is greater than L2, the DCI format of simultaneous scheduling service cell group 2 is appended with (L1-L2) zeros, so that the payload size of the DCI format of the simultaneous scheduling service cell group 2 is the same as the payload size of the DCI format of the simultaneous scheduling service cell group 1. The advantage of using this method is that it may reduce the number of different DCI format sizes for blind detection by the UE as much as possible while ensuring the PDSCH scheduling requirement.

According to another embodiment of the present disclosure, if the UE is configured with more than one simultaneous scheduling service cell group, the number of service cells within each simultaneous scheduling service cell group i is Mi, the number of information bits of each DCI format for scheduling each simultaneous scheduling service cell group is determined according to PDSCH configurations of activated service cells in all configured service cells within the simultaneous scheduling service cell group (or non-dormancy service cells in the activated service cells, the non-dormancy service cell means that the activated BWP of the service cell is not a dormancy BWP), and then, in order not to increase the number of different DCI sizes that need to be blindly detected by the UE too much, it is necessary to align the payload sizes of the DCI formats for scheduling multiple simultaneous scheduling service cell groups. A possible method is to identify a simultaneous scheduling service cell group with the largest number of information bits of a DCI format among multiple simultaneous scheduling service cell groups, use the number of information bits of the DCI format of this simultaneous scheduling service cell group as the payload size of the DCI format, and then the number of information bits of the DCI formats of the remaining simultaneous scheduling service cell groups are appended with zeros, so that the payload sizes of the DCI formats appended with zeros are the same as the largest number of information bits of above DCI format.

For example, the UE is configured with six service cells, namely service cell 1, service cell 2, service cell 3, service cell 4, service cell 5 and service cell 6, where the PDSCH of the service cell 1 is self-carrier-scheduled by the PDCCH of the service cell 1, the PDSCHs of the service cell 2, service cell 3, service cell 4, service cell 5 and service cell 6 are cross-carrier-scheduled by the PDCCH of the service cell 1, and the maximum number N of service cells whose PDSCHs are simultaneously scheduled by one DCI format configured for the UE is equal to 4, and the UE is configured with two simultaneous scheduling service cell groups, namely simultaneous scheduling service cell group 1 and simultaneous scheduling service cell group 2, where the simultaneous scheduling service cell group 1 includes the service cell 1, the service cell 2, the service cell 3 and the service cell 4, and the simultaneous scheduling service cell group 2 includes the service cell 1, the service cell 5 and the service cell 6, and the number of information bits of a DCI format is determined as L1 according to PDSCH configurations of activated service cells (for example, the service cell 1, the service cell 2, the service cell 3, and the service cell 4 are activated service cell) in the service cell 1, the service cell 2, the service cell 3 and the service cell 4 included in the simultaneous scheduling service cell group 1, and the number of information bits of a DCI format is determined as L2 according to PDSCH configurations of activated service cells (for example, the service cell 1 and the service cell 6 are activated service cell) in the service cell 1, the service cell 5 and the service cell 6 included in the simultaneous scheduling service cell group 2 (the service cell 5 included in the simultaneous scheduling service cell group 2 is an inactivated service cell). It is assumed that L1 is greater than L2, the DCI format of the simultaneous scheduling service cell group 2 is appended with (L1-L2) zeros, so that the payload size of the DCI format of the simultaneous scheduling service cell group 2 is the same as the payload size of the DCI format of the simultaneous scheduling service cell group 1. The advantage of using this method is that it may reduce the number of different DCI format sizes for blind detection by the UE as much as possible while ensuring the PDSCH scheduling requirement.

After the alignment operation, the simultaneous scheduling service cell group to be used may be found based on the first configuration information.

In a case where a service cell is configured with one bandwidth part (BWP), PDSCH and/or PUSCH configuration of the service cell may be determined directly from PDSCH and/or PUSCH configuration of the BWP in the service cell in the manner described above.

According to the embodiments of the present disclosure, in determining the PDSCH and/or PUSCH configuration of the service cell, the reference bandwidth part (BWP) of each of the service cells to be scheduled by the DCI format may be determined, and the PDSCH and/or PUSCH configuration of the reference BWP of each service cell is used as the final PDSCH and/or PUSCH configuration.

The reference BWP may be one of the following items: an activated BWP in a service cell; a BWP having a minimum index in a service cell; a BWP having a maximum index in a service cell; a BWP configured based on a high-level signaling in a service cell; a BWP with a same subcarrier space configuration as an activated BWP in a scheduling service cell; a BWP allowing PDSCHs of multiple service cells to be scheduled simultaneously by the one DCI format; and an activated BWP allowing PDSCHs of multiple service cells to be scheduled simultaneously by the one DCI format.

As an example, for each service cell, an activated BWP in the service cell may be used as a reference BWP of the service cell, and in a case where there is no activated BWP in a service cell, one of the following BWPs in the service cell may be used as a reference BWP of the service cell: a BWP with a minimum index, a BWP with a maximum index, a BWP configured based on a high level signaling, a BWP with a same subcarrier space configuration as an activated BWP in a scheduling service cell, and a BWP allowing PDSCHs of multiple service cells to be scheduled simultaneously by the DCI format.

As another example, when there is no activated BWP in a service cell, or when an activated BWP is a dormancy BWP, the service cell may be removed when calculating a payload size of a DCI format, i.e., a PDSCH and/or PUSCH configuration of the service cell is not considered.

As yet another example, in a case where a service cell does not have a reference BWP of the above type, the service cell may be removed when calculating a payload size of a DCI format, i.e. a PDSCH and/or PUSCH configuration of the service cell is not considered.

In step S520, the DCI format is generated based on the payload size of the one DCI format, and a physical downlink control channel (PDCCH) including the DCI format is transmitted. After determining the payload size of one DCI format, the DCI format corresponding to that payload size may be generated, and then the DCI format may be transmitted via the PDCCH.

In step S520, first configuration information including the information related to the at least one service cell scheduled by the one DCI format is transmitted.

The UE may detect a DCI format corresponding to the payload size of the DCI format based on the received first configuration information, thereby receiving a PDSCH and/or PUSCH scheduled by that DCI format.

According to another embodiment of the present disclosure, after the base station determines a payload size of one DCI format, the payload size may be sent to the UE such that the UE may monitor the corresponding DCI format in the PDCCH according to the payload size.

In the present disclosure, the payload size or the number of bits of the DCI format may be calculated by the base station or by the UE.

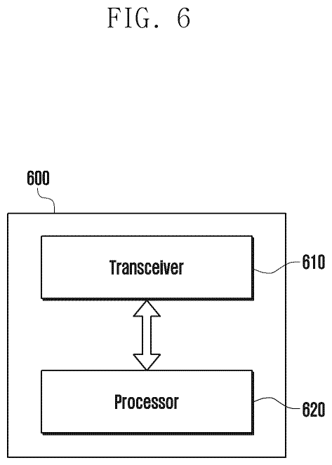

FIG. 6 illustrates a block diagram of an user equipment in a communication system provided by an embodiment of the present application. Referring to FIG. 6, the user equipment 600 may include a transceiver 610 and a processor 620, wherein the processor 620 is coupled to the transceiver 610 and configured to receive, from a base station, first configuration information, wherein the first configuration information includes information related to at least one service cell scheduled by one downlink control information (DCI) format; determine a payload size of the one DCI format according to the information related to the at least one service cell scheduled by the one DCI format; and detect, according to the payload size of the one DCI format, a physical downlink control channel (PDCCH) including the DCI format. In addition, the processor 620 may further receive, from the base station, second configuration information, wherein the second configuration information includes information related to the number of service cells scheduled by the one DCI format.

Details of the operations of the method performed by the UE described above may refer to the description of FIG. 4 and are not repeated here.

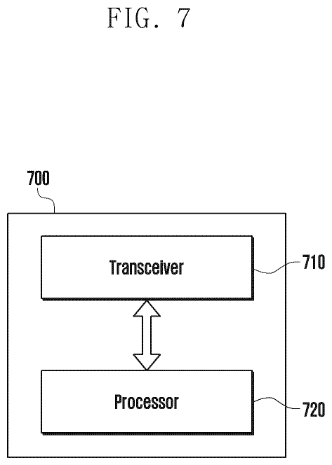

FIG. 7 illustrates a block diagram of a base station in a communication system provided by an embodiment of the present application. Referring to FIG. 7, the base station 700 may include a transceiver 710 and a processor 720, wherein the processor 720 is coupled to the transceiver 710 and configured to determine a payload size of one downlink control information (DCI) format according to information related to at least one service cell scheduled by the one DCI format; generate, based on the payload size of the one DCI format, the DCI format, and transmit a physical downlink control channel (PDCCH)including the DCI format; and transmit first configuration information including the information related to the at least one service cell scheduled by the one DCI format. In addition, the processor 720 may further transmit second configuration information including information related to the number of service cells scheduled by the one DCI format.

Details of the operations of the method performed by the base station described above may refer to the description of FIGS. 4 and 5 and are not repeated here.

According to the embodiments of the present disclosure, an electronic device is further provided, including: at least one processor; and at least one memory storing computer-executable instructions, wherein the computer-executable instructions, when run by the at least one processor, cause the at least one processor to perform any one of the methods as described above.

As an example, the electronic device may be a PC computer, a tablet device, a personal digital assistant, a smartphone, or any other device capable of executing the above instruction set. Here, the electronic device does not have to be a single electronic device, but may also be any set of devices or circuits capable of executing the above instructions (or instruction set) individually or jointly. The electronic device may also be a part of an integrated control system or system manager, or may be configured as a portable electronic device that interfaces locally or remotely (e.g., via wireless transmission).

In the electronic device, the processor may include a central processing unit (CPU), graphics processing unit (GPU), programmable logic device, special purpose processor system, microcontroller or microprocessor. By way of example and not limitation, the processor may also include analog processors, digital processors, microprocessors, multi-core processors, processor arrays, network processors, and the like.

The processor may execute instructions or code stored in the memory, which may also store data. Instructions and data may also be sent and received over a network via a network interface, which may employ any known transport protocol.

The memory may be integrated with the processor, e.g., a RAM or flash memory is arranged within an integrated circuit microprocessor or the like. Additionally, the memory may include a separate device such as an external disk drive, storage array, or any other storage device that may be used by a database system. The memory and the processor may be operatively coupled, or may communicate with each other, e.g., through I/O ports, network connections, etc., to enable the processor to read files stored in the memory.

In addition, the electronic device may also include video displays (e.g. liquid crystal display) and user interaction interfaces (e.g. keyboard, mouse, touch input device, etc.). All components of the electronic device may be connected to each other via a bus and/ or a network.

According to an embodiment of the present disclosure, a computer readable storage medium storing instructions is also provided. The instructions, when executed by at least one processor, causes the at least one processor to perform any of the above methods according to the exemplary embodiments of the present disclosure. Examples of computer-readable storage media herein include: Read Only Memory (ROM), Random Access Programmable Read Only Memory (RAPROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, Hard Disk Drive (HDD), Solid State Drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs. The instructions or computer programs in the computer-readable storage medium described above may be executed in an environment deployed in a computer device, such as client, host, proxy device, server, etc. In addition, in one example, the computer programs and any associated data, data files, and data structures are distributed on a networked computer system, so that the computer programs and any associated data, data files, and data structures are stored, accessed and executed through one or more processors or computers in a distributed manner.

It should be noted that the terms “first”, “second”, “third”, “fourth” , “1”, “2”, etc. (if present) used in the specification and claims and the accompanying drawings above of the present application are used to distinguish similar objects and are not necessary for describing a particular order or sequence. It should be understood that the data so used is interchangeable in appropriate cases so that the embodiments of the present application described herein may be implemented in an order other than that illustrated or described herein.

It should be understood that while the flowcharts of the embodiments of the present application indicate the individual operational steps by arrows, the order of these implementation steps is not limited to the order indicated by the arrows. Unless explicitly stated herein, in some implementation scenarios of the embodiments of the present application, the implementation steps in the respective flowcharts may be performed in other orders as desired. In addition, some or all of the steps in each flowchart may include multiple sub-steps or multiple stages based on actual implementation scenarios. Some or all of these sub-steps or stages may be executed at the same moment, and each of these sub-steps or stages may also be executed separately at different moments. In the scenarios where the execution moments are different, the order of execution of these sub-steps or stages may be flexibly configured according to the needs, and the embodiments of the present application are not limited thereto.

The above description is only an optional implementation of part of the implementation scenarios of the present application. It should be noted that for those ordinary skill in the art, other similar means of implementation based on the technical idea of the present application, without departing from the technical idea of the present application, also fall within the scope of protection of the embodiments of the present application.

Other embodiments of the present disclosure will readily be conceived by those skill in the art after considering the specification and practicing the invention disclosed herein. The present application is intended to cover any variation, use, or adaptation of the present disclosure that follows the general principle of the present disclosure and includes commonly known or customary technical means in the art not disclosed herein. The specification and embodiments are to be considered exemplary only, and the true scope and spirit of the disclosure is limited by the claims.

1.-15. (canceled)

16. A method performed by a terminal in a communication system, the method comprising:
receiving, from a base station, configuration information including information related to scheduled cells;
receiving, from the base station, downlink control information (DCI) for scheduling of at least one physical downlink shared channel (PDSCH) or at least one physical uplink shared channel (PUSCH); and
performing data transmission based on the at least one PDSCH or data reception based on the at least one PUSCH,
wherein the DCI is appended with zeros until a payload size of the DCI equals to a largest payload size among the scheduled cells.

17. The method of claim 16, wherein the information related to the scheduled cells includes information associated with a group of co-scheduled cells.

18. The method of claim 16, wherein the configuration information includes a cell identifier of the scheduled cells.

19. The method of claim 16, wherein the largest payload size is identified based on a configuration of an active bandwidth part of the scheduled cells.

20. A method performed by a base station in a communication system, the method comprising:
transmitting, to a terminal, first configuration information including information related to scheduled cells;
transmitting, to the terminal, downlink control information (DCI) for scheduling of at least one physical downlink shared channel (PDSCH) or at least one physical uplink shared channel (PUSCH); and
performing data transmission based on the at least one PUSCH or data reception based on the at least one PDSCH,
wherein the DCI is appended with zeros until a payload size of the DCI equals to a largest payload size among the scheduled cells.

21. The method of claim 20, wherein the information related to the scheduled cells includes information associated with a group of co-scheduled cells.

22. The method of claim 20, wherein the configuration information includes a cell identifier of the scheduled cells.

23. The method of claim 20, wherein the largest payload size is identified based on a configuration of an active bandwidth part of the scheduled cells.

24. A terminal in a communication system, the terminal comprising.
a transceiver; and
a processor coupled to the transceiver and configured to:
receive, from a base station, configuration information including information related to scheduled cells,
receive, from the base station, downlink control information (DCI) for scheduling of at least one physical downlink shared channel (PDSCH) or at least one physical uplink shared channel (PUSCH), and
perform data transmission based on the at least one PDSCH or data reception based on the at least one PUSCH,
wherein the DCI is appended with zeros until a payload size of the DCI equals to a largest payload size among the scheduled cells.

25. The terminal of claim 24, wherein the information related to the scheduled cells includes information associated with a group of co-scheduled cells.

26. The terminal of claim 24, wherein the configuration information includes a cell identifier of the scheduled cells.

27. The terminal of claim 24, wherein the largest payload size is identified based on a configuration of an active bandwidth part of the scheduled cells.

28. A base station in a communication system, the base station comprising.
a transceiver; and
a processor coupled to the transceiver and configured to:
transmit to a terminal, first configuration information including information related to scheduled cells,
transmit, to the terminal, downlink control information (DCI) for scheduling of at least one physical downlink shared channel (PDSCH) or at least one physical uplink shared channel (PUSCH), and
perform data transmission based on the at least one PUSCH or data reception based on the at least one PDSCH,
wherein the DCI is appended with zeros until a payload size of the DCI equals to a largest payload size among the scheduled cells.

29. The base station of claim 28, wherein the information related to the scheduled cells includes information associated with a group of co-scheduled cells.

30. The base station of claim 28,
wherein the configuration information includes a cell identifier of the scheduled cells, and
wherein the largest payload size is identified based on a configuration of an active bandwidth part of the scheduled cells.
